(19) United States
(12) Patent Application Publication
(10) Pub. No.: US 2008/0301758 A1
(43) Pub. Date: Dec. 4, 2008

(54) Distributed knowledge access control

(75) Inventors: Yuri Gurevich, Redmond, WA (US); Muthukrishnan Paramasivam, Seattle, WA (US); Itay Neeman, Beverly Hills, CA (US)

Correspondence Address: WOODCOCK WASHBURN LLP (MICROSOFT CORPORATION), CIRA CENTRE, 12TH FLOOR, 2929 ARCH STREET, PHILADELPHIA, PA, 19104-2891, US

(73) Assignee: Microsoft Corporation, Redmond, WA (US)

(21) Appl. No.: 11/809,856

(22) Filed: May 31, 2007

(51) Int. Cl. H04L 9/00

(52) U.S. Cl. 726/1

(57) ABSTRACT

Techniques for distributed knowledge access control are disclosed herein. These techniques may enable access control information to be provided in the form of a statement that includes an assertion and a construct that targets the assertion to one or more intended entities. By targeting the statement to intended entities, the construct may help protect resources from unauthorized use and may also help protect the issuer of the statement from accountability resulting from misuse of the statement.

### BACKGROUND

In conventional access control systems, users request access to a resource, and access is granted if the resource's corresponding access control policy allows for access. The access control policy for the resource is stored and protected locally with the resource. In a distributed environment, this “closed” model has at least two major limitations. First, policy configuration cannot take place “remotely.” Rather, it is necessary to “connect” to the resource in order to configure the resource's control policy. Second, since control policies are localized, they tend to be very “static,” meaning that only principals that are known a priori can be granted authorization for the resource by the access control policy.

To address these problems, many approaches have been developed that allow for specifying policy in the form of declarative assertions secured by cryptographic means. Such assertions are sent from a remote source and then put together locally at the resource to determine whether they imply that access ought to be provided. These approaches are more flexible in expressing policy than the “closed” model in that the resource manager is able to evaluate the assertions and the degree to which it trusts the issuer of the assertions. For example, an access policy for a first resource R1 may state “Give read access to R1 to whoever John says is an employee.” To request access to R1, a first entity E1 may provide an assertion from John of the form “John says E1 is an employee.” In a more sophisticated scenario, E1 may provide an assertion from a second entity E2 of the form “E2 says E1 is an employee,” and another assertion from John of the form “John says E2 is authorized to make statements regarding who is an employee.”

A limitation associated with the existing “Issuer says Assertion” format described above is that such assertions are typically not directed towards any purpose; rather they are simply assumed to hold true for all contexts and usages. Thus, once an assertion has been issued, it is not possible for the issuer to control the use of the assertion. This lack of control may allow statements to be misused in order to allow some entities to gain access to resources that they are not authorized to use. For example, consider the scenario in which the legal drinking age for alcoholic beverages is 18 in Nevada, but the legal drinking age for alcoholic beverages is 21 in Utah. Suppose that an age verification service has determined that John Doe is 18 years old, and that the age verification service (“AVS”) issues an assertion intended for the Nevada State Police that “AVS says John Doe is of legal drinking age.” Now, suppose that John Doe wants to go drinking in Utah for the weekend, and that John Doe is somehow able to obtain access to the above assertion. In the existing “Issuer says Assertion” format, John Doe may be able to use the above assertion to show that he is of legal drinking age in Utah, even though he is only 18 years old. This is because, although the above assertion is intended only for the Nevada State Police (that enforce a legal drinking age of 18), there is no construct in the above assertion to show that the assertion is intended only for the Nevada State Police. Thus, for example, as long as the Utah State Police trust the age verification service, John Doe can provide the above assertion to the Utah State Police to gain access to alcohol in Utah.

In addition to allowing resources to be accessed by non-authorized entities, the existing “Issuer says Assertion” format is also disadvantageous because it may leave issuers of misused statements accountable even when their statements are provided to entities other than the entities for which the statements were originally intended. For example, in the above scenario, the Utah State Police may “blame” the age verification service for issuing the assertion that “John Doe is of legal drinking age.” This is because there was nothing in the statement to show that the statement was intended only for Nevada. Thus, the Utah State Police may have no way of knowing that the statement was not intended for Utah. If the age verification service is blamed for issuing the statement, then a number of unwanted consequences may occur. For example, the Utah State Police (and other similar entities) may choose to designate the age verification service as an entity that cannot be trusted.

To address these problems, some access control schemes associate a fixed lifetime to an assertion. The assertion is no longer valid after expiration of the lifetime. However, such provisions do not provide a guarantee of usage only as intended and can inhibit the issuer of the assertion from making such assertions, thereby precluding some scenarios that rely upon those assertions. Another approach is to maintain distribution information outside of policy by, for example, encrypting the policy to an intended recipient. However, these techniques have the potential of misuse if, for example, the intended recipient misuses the policy or if the encryption key is compromised. These techniques also do not remove the issuer of the statement from accountability towards the assertion. Yet another approach is to allow an issuer of the assertion to very specifically enumerate the usages of the assertion. However, such an enumeration can be tedious and error-prone and may also curb the flexibility that is useful in such systems.

### SUMMARY

Techniques for distributed knowledge access control are disclosed herein. These techniques may enable access control information to be provided in the form of a statement that includes an assertion and a construct that targets the assertion to one or more intended entities. By targeting the statement to intended entities, the construct may help protect resources from unauthorized use and may also help protect the issuer of the statement from accountability resulting from misuse of the statement.

Upon receiving access control information, a resource manager may examine the information to determine a known portion of the information. The known portion of the information may include either all of the information or less than all the information. The known portion of the information may include an assertion that is made by the resource manager itself or an assertion that is made by another entity and that is specifically targeted to the resource manager. The known portion of the information may also include information that logically follows from other known information. Upon identifying the known portion of the information, the resource manager may apply one or more trust policies to filter the known information into information that is known and trusted. The known and trusted and trusted information may then be incorporated into one or more applicable access control policies.

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

### BRIEF DESCRIPTION OF THE DRAWINGS

The illustrative embodiments will be better understood after reading the following detailed description with reference to the appended drawings, in which:

FIG. 1 is a block diagram representing an exemplary resource access control system;

FIG. 2 is a flowchart representing an exemplary method of issuing targeted access control information;

FIG. 3 is a flowchart representing an exemplary method of evaluating access control information; and

FIG. 4 is a block diagram representing an exemplary computing device.

### DETAILED DESCRIPTION

The inventive subject matter is described with specificity to meet statutory requirements. However, the description itself is not intended to limit the scope of this patent. Rather, it is contemplated that the claimed subject matter might also be embodied in other ways, to include different steps or combinations of steps similar to the ones described in this document, in conjunction with other present or future technologies.

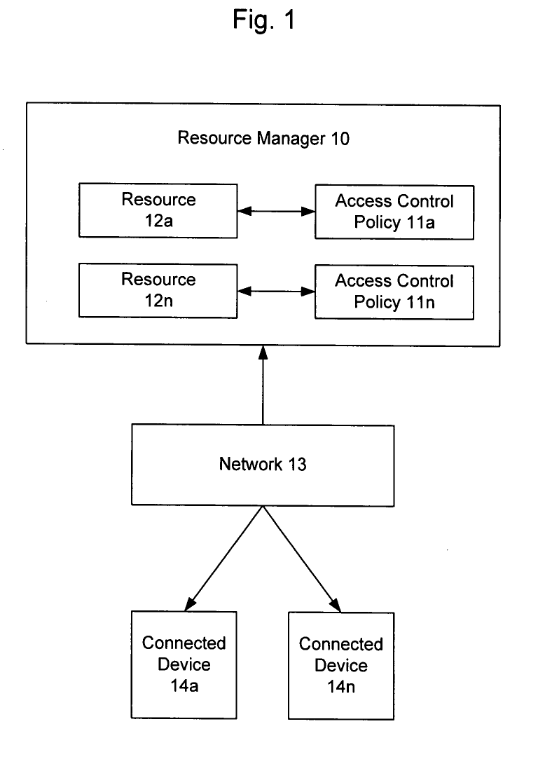

FIG. 1 is a block diagram representing an exemplary resource access control system. Resource manager 10 controls access to resources 12a-n. The term resource, as used herein, refers to any item that is useful in a computing environment including, but not limited to, hardware, software, content, services, or any other useful item. Resource manager 10 regulates access to resources 12a-n according to access control policies 11a-n. As should be appreciated, each resource need not necessarily have its own unique access control policy. Rather, a single access control policy may be used to regulate access to multiple resources. As should also be appreciated, the system of FIG. 1 may include any number of resources 12, resource access control policies 11, and connected devices 14.

Connected devices 14a-n communicate with resource manager 10 via network 13. Network 13 may be a local area network (LAN) or a wide area network (WAN) such as the Internet. As should be appreciated, connected devices 14a-n need not necessarily have a direct connection to resource manager 10 and may communicate with resource manager 10 via one or more intermediate devices. Connected devices 14a-n may be used, for example, to request access to resources 12a-n managed by resource manager 10. Additionally, a user and/or software application working or executing locally at resource manager 10 may also request access to resources 12a-n managed by resource manager 10. When resource manager 10 receives a request to access one of its managed resources 12a-n, resource manager 10 may use one or more corresponding access control policies 11a-n to determine whether or not the requester is authorized to access the requested resource 12a-n.

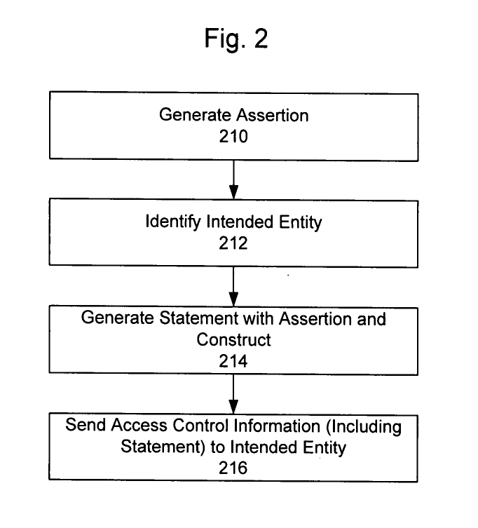

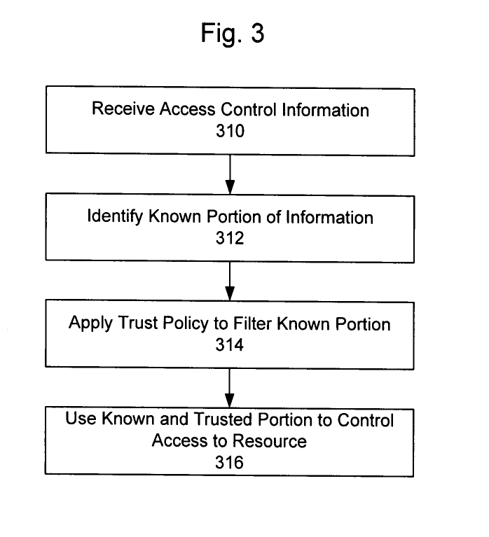

Connected devices 14a-n may also be used to issue and submit access control information to resource manager 10. Additionally, a user and/or software application working or executing locally at resource manager 10 may also issue and submit access control information to resource manager 10. Some exemplary techniques that may be employed to issue access control information for submission to resource manager 10 are set forth in detail below with reference to FIG. 2. When access control information is provided to resource manager 10, resource manager 10 may evaluate the access control information, and, if appropriate, may insert all or a portion of the received access control information into one or more appropriate access control policies 11a-n. Some exemplary techniques that may be employed by resource manager 10 to evaluate incoming access control information are set forth in detail below with reference to FIG. 3.

A flowchart representing an exemplary method of issuing targeted access control information is shown in FIG. 2. As will be described in detail below, such access control information is “targeted” in the sense that the issuer of the information can direct the information to certain “intended” entities, which are entities that are authorized to use the statement. The ability to target the information in this manner may help protect resources from unauthorized use and may also help protect the issuer of the statement from accountability resulting from misuse of the statement.

The acts described in FIG. 2 may be performed by an entity which will hereinafter be referred to as an “issuer.” The issuer may be, for example, an organization, authority, individual, service, software application, or other entity that issues resource access control information (including, possibly, a resource manager itself). As set forth above, the issuer may be working or executing either locally at resource manager 10 or remotely at a connected device 14a-n. Additionally, different portions of the issuing process may be distributed across multiple different issuing entities.

At act 210, the issuer generates an assertion. The assertion may be any declaration that is either directly or indirectly relevant to management of one or more resources. Specifically, an entity may generate an assertion granting one or more entities (including the issuer itself) authority over one or more resources. For example, a first entity El can generate an assertion granting a second entity E2 authority over a first resource R1. Such an assertion may be represented by the following notation:

E1 says (E2=>R1)

As another example, an assertion can provide credentials for an entity requesting access to a resource. For example, a control policy for a second resource R2 may state “Give read access to R2 to whoever E1 says is an employee.” In this case, E1 may generate an assertion that “E2 is an employee.” E2 can then present this assertion to the resource manager to gain access to R2.

As yet another example, an assertion can provide credentials for entities that make assertions about other entities. For example, suppose a third entity E3 is not recognized by the resource manager. Also suppose that E3 generates an assertion that “E2 is an employee.” In this case, E1 may generate an assertion that “E3 is authorized to make assertions regarding employees.” E2 can then present both E1's and E3's assertions to the resource manager to gain access to R2.

At act 212, one or more intended entities are identified for which the assertion generated at act to 210 is targeted. The intended entities may be, for example, various resource managers or any other organization, authority, individual, group, service, application, device, feature, address, or other entity associated, either directly or indirectly, with any resource access control procedures. The intended entities may be identified using any identification technique such as, for example, a name, address (e.g., Internet Protocol (IP) address), identification number, port number, serial number, or any other identifier. The intended entities need not necessarily be individually identified and may be collectively identified. In particular, the intended entities may be identified using a collection such as a specified organization, network, geographic area, device, address range. For example, the intended entities may be identified as all entities in the Microsoft Corp. local area network (LAN) or all entities in the state of Nevada. Additionally, if an assertion is not intended to be restricted to any particular entities, then the intended entities may be identified, for example, as “everyone” or “all entities.”

At act 214, a statement is generated that includes the assertion generated at act 210 (and possibly multiple assertions) and a construct that targets the assertion or assertions to the intended entity or entities. The construct may, for example, use the phrase “says to” to designate the intended entity. Thus the statement may assume the following form:
Issuer says to Intended Entity (Assertion)
   For example, consider the exemplary assertion above in which the first entity E1 grants the second entity E2 authority over the first resource R1 (represented by the notation “E2=>R1”). Now suppose that this assertion is intended only to be used only by a first resource manager RM1. The targeted assertion may be represented by the following notation:

E1 says to RM1 (E2=>R1)

At act 216, the issuer sends access control information including the statement to the intended entity. In addition to the statement, the access control information may include any other information relevant to resource access control such as, for example, a proof of identity that the issuer is, in fact, who the issuer purports to be. The access control information may be sent either directly to the intended entity or in directly via one or more intermediate entities. For example, E1 may first send the statement listed above “E1 says to RM1 (E2=>R1)” to E2. E2 may then present the statement to RM1 to gain access to R1.

A flowchart representing an exemplary method of evaluating access control information is shown in FIG. 3. At act 310, a resource manager receives access control information. The access control information may be received either directly from an issuer of the access control information (including possibly a resource manager itself) or indirectly via one or more intermediate entities. The access control information may be provided locally at the resource manger or from a remote device or location. The information received at act 310 may, although need not necessarily, be “targeted” access control information issued using a method such as the exemplary method described above and depicted in FIG. 2.

At act 312, the resource manager identifies a known portion of the received access control information. The known portion may be either all of the information or less than all of the information. In some cases none of the information may be known. The known portion of the information is information that meets at least one of three criteria.

The first criteria is that an entity knows all information that is issued by the entity itself. For example, suppose resource manager RM1 generates a statement including an assertion granting entity E4 access over resource R3. This statement is represented by the notation “RM1 says E4=>R3” (note that this is not “targeted” access control information). In this case, even though the statement is not targeted to RM1, RM1 will nevertheless “know” the statement because the statement was issued by RM1.

The second criteria is that an entity knows all information that is issued by another entity and targeted to the entity. For example, suppose that E5 generates a statement including an assertion targeted to resource manager RM1 granting entity E2 access over resource R1. This statement is represented by the notation “E5 says to RM1 (E2=>R1).” In this case, even though RM1 did not issue the statement, RM1 will nevertheless “know” the statement because the statement was issued by another entity and targeted to RM1.

The third criteria is that an entity knows all information that follows from other known information. To illustrate this concept, suppose resource manager RM1 knows two assertions: A1 and A2. Also suppose that a third assertion A3 logically follows from assertions A1 and A2. In this case, RM1 will also know assertion A3 because it logically follows from assertions A1 and A2. For example, suppose an access control policy for a resource says “grant access only to people that were born in June.” Now suppose RM1 receives the following statements:
E5 says to RM1 (Betty was born after May)
E6 says to RM1 (Betty was born before July)
   In this case, RM1 knows the assertions that Betty was born after May and that Betty was born before July. The two assertions logically imply that Betty was born in June, and so RM1 knows this third assertion as well. As should be appreciated, a number of different standards may be employed by different systems to compute what information logically follows from other information. The techniques described herein are not intended to be limited to any single standard for computing such logically following information.

At act 314, the resource manager applies a trust policy to filter the known portion of the information into a known and trusted portion of information. Trust policies are well known tools in the art for determining whether or not various entities can be trusted. Trust policies can apply to individual entities or collectively to groups of entities. Obviously, the resource manager will likely trust itself, and, therefore, information issued by the resource manager itself will likely be trusted. However, other entities that issue information targeted for the resource manager may, in certain circumstances, not be recognized and/or trusted by the resource manager. For example, consider the statement issued by E7 in which “E7 says to RM1 (E2=>R1).” In this case, if E7 is a trusted entity, then the statement will constitute known and trusted information. However, if E7 is not a trusted entity, then the statement, although it is known, will not be trusted information. If a known statement is issued by a non-trusted entity, then the statement may simply be disregarded. Alternatively, the statement may be saved for possible future use if, for example, the status of the currently non-trusted entity is later changed, and the entity becomes a trusted entity.

If the trust policies applied by the resource manager do not include information for determining whether E7 is trusted or non-trusted, then E7 may be considered a non-recognized entity. In this case, if E7 is non-recognized, the statement may, for example, be set aside until such time as a determination can be made regarding whether E7 is trusted or not. The statement may also be disregarded.

At act 316, the known and trusted portion of the access control information is used to control access to one or more resources. Any number of existing techniques may be employed to determine to which (if any) resources the known and trusted portion of the access control information is applicable. If the known and trusted portion of the information is applicable to any existing resources, then the known and trusted portion of the information may be entered into one or more resource access control policies corresponding to the applicable existing resources. If the known and trusted portion of the information is not applicable to any existing resources or resource access control policies, then the known and trusted portion of the information may, for example, be stored in memory for possible future use. Alternatively, if the known and trusted portion information is not applicable to any existing resources or resource access control policies, then it may simply be disregarded.

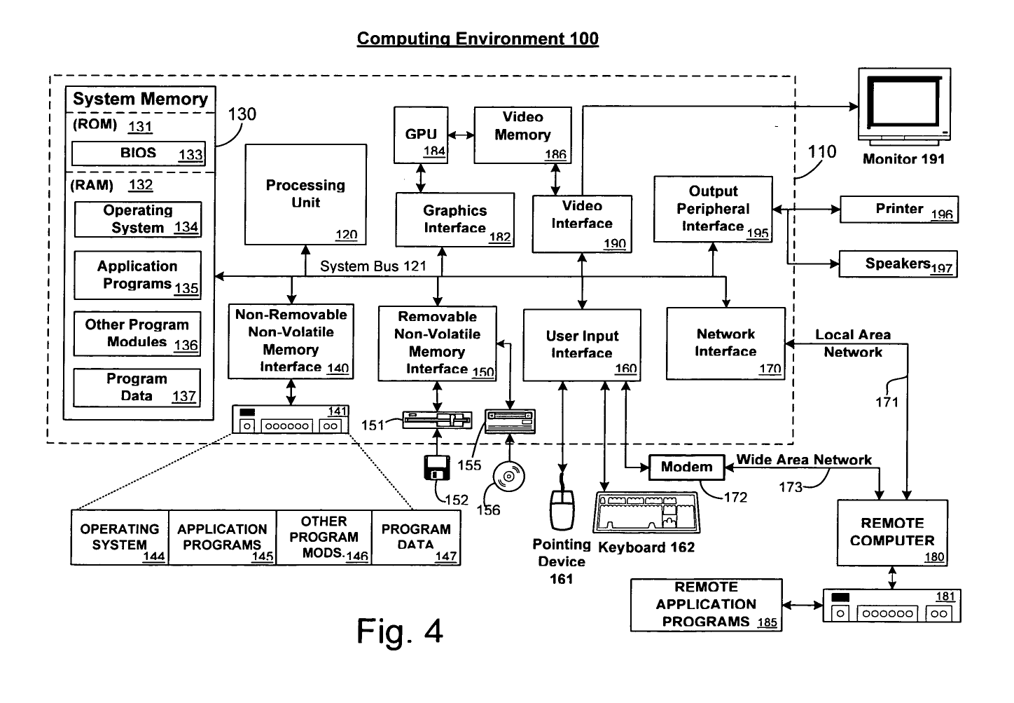

FIG. 4 illustrates an example of a suitable computing system environment 100 in which the subject matter described above may be implemented. The computing system environment 100 is only one example of a suitable computing environment and is not intended to suggest any limitation as to the scope of use or functionality of the subject matter described above. Neither should the computing environment 100 be interpreted as having any dependency or requirement relating to any one or combination of components illustrated in the exemplary operating environment 100.

With reference to FIG. 4, computing system environment 100 includes a general purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus (also known as Mezzanine bus).

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media include both volatile and nonvolatile, removable and non-removable media implemented in any method or technology for storage of information such as computer readable instructions, data structures, program modules or other data. Computer storage media include, but are not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other medium which can be used to store the desired information and which can be accessed by computer 110. Communication media typically embody computer readable instructions, data structures, program modules or other data in a modulated data signal such as a carrier wave or other transport mechanism and include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared and other wireless media. Combinations of any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 4 illustrates operating system 134, application programs 135, other program modules 136, and program data 137.

The computer 110 may also include other removable/non-removable, volatile/nonvolatile computer storage media. By way of example only, FIG. 4 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156, such as a CD-RW, DVD-RW or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 4 provide storage of computer readable instructions, data structures, program modules and other data for the computer 110. In FIG. 4, for example, hard disk drive 141 is illustrated as storing operating system 144, application programs 145, other program modules 146 and program data 147. Note that these components can either be the same as or different from operating system 134, application programs 135, other program modules 136 and program data 137. Operating system 144, application programs 145, other program modules 146 and program data 147 are given different numbers here to illustrate that, at a minimum, they are different copies. A user may enter commands and information into the computer 110 through input devices such as a keyboard 162 and pointing device 161, such as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus 121, but may be connected by other interface and bus structures, such as a parallel port, game port or a universal serial bus (USB). A graphics interface 182 may also be connected to the system bus 121. One or more graphics processing units (GPUs) 184 may communicate with graphics interface 182. A monitor 191 or other type of display device is also connected to the system bus 121 via an interface, such as a video interface 190, which may in turn communicate with video memory 186. In addition to monitor 191, computers may also include other peripheral output devices such as speakers 197 and printer 196, which may be connected through an output peripheral interface 195.

The computer 110 may operate in a networked or distributed environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 4. The logical connections depicted in FIG. 4 include a local area network (LAN) 171 and a wide area network (WAN) 173, but may also include other networks/buses. Such networking environments are commonplace in homes, offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 4 illustrates remote application programs 185 as residing on memory device 181. It will be appreciated that the network connections shown are exemplary and other means of establishing a communications link between the computers may be used.

Although the subject matter has been described in language specific to the structural features and/or methodological acts, it is to be understood that the subject matter defined in the appended claims is not necessarily limited to the specific features or acts described above. Rather, the specific features or acts described above are disclosed as example forms of implementing the claims.

What is claimed:

1. A computer-readable medium having stored thereon computer-executable instructions for controlling, by an entity, access to a resource based on information by performing the following steps:
determining a known portion the information, the known portion comprising an assertion issued by the entity itself or an assertion issued by another entity and targeted to the entity; and
determining whether to grant access to the resource based on the known portion of the information.

2. The computer-readable medium of claim 1, wherein the known portion comprises all of the information.

3. The computer-readable medium of claim 1, wherein the known portion comprises less than all of the information.

4. The computer-readable medium of claim 1, wherein the computer-executable instructions are further for performing the steps of:
applying a trust policy to determine whether another entity that issued the known portion of the information is a trusted entity;
if the other entity is not a trusted entity, disregarding the known portion of the information; and
if the other entity is a trusted entity, determining whether to grant access to the resource based on the known portion of the information.

5. The computer-readable medium of claim 1, wherein the known portion of the information further comprises information that logically follows from other known information.

6. The computer-readable medium of claim 1, wherein the computer-executable instructions are further for performing the steps of:
identifying an unknown portion of the information; and
disregarding the unknown portion of the information.

7. The computer-readable medium of claim 1, wherein the known portion comprises a statement having the assertion and a construct that targets the assertion to the entity.

8. The computer-readable medium of claim 7, wherein the construct protects an issuer of the statement from accountability if the statement is used by an entity that is not identified by the construct.

9. The computer-readable medium of claim 1, wherein the statement is targeted exclusively to the entity.

10. The computer-readable medium of claim 1, wherein the statement is targeted to the entity and to at least one other entity.

11. A computer-readable medium having stored thereon computer-executable instructions for performing the following steps:
generating an assertion;
identifying an intended entity to which the assertion is targeted; and
generating a statement comprising the assertion and a construct that targets the assertion to the intended entity.

12. The computer-readable medium of claim 11, wherein the construct targets the statement exclusively to the intended entity.

13. The computer-readable medium of claim 11, wherein the construct targets the statement to the intended entity and to at least one other intended entity.

14. The computer-readable medium of claim 11, wherein the construct protects an issuer of the statement from accountability if the statement is used by a non-intended entity.

15. The computer-readable medium of claim 11, wherein the assertion grants authority over a resource.

16. The computer-readable medium of claim 11, wherein the computer-executable instructions are further for performing the step of sending the statement to the intended entity.

17. A method for controlling, by an entity, access to a resource based on information, the method comprising:
determining a known portion of the information, the known portion comprising an assertion issued by the entity itself or an assertion issued by another entity and targeted to the entity; and
determining whether to grant access to the resource based on the known portion of the information.

18. The method of claim 17, further comprising:
applying a trust policy to determine whether another entity that issued the known portion of the information is a trusted entity;
if the other entity is not a trusted entity, disregarding the known portion of the information; and
if the other entity is a trusted entity, determining whether to grant access to the resource based on the known portion of the information.

19. The method of claim 17, wherein the known portion of the information further comprises information that logically follows from other known information.

20. The method of claim 17, wherein the known portion comprises a statement having the assertion and a construct that targets the assertion to the entity.
